(19) United States
(12) Patent Application Publication
(10) Pub. No.: US 2005/0003255 A1
(43) Pub. Date: Jan. 6, 2005

(54) Membrane electrode assembly, manufacturing process therefor and solid-polymer fuel cell

(76) Inventors: Kunihiko Shimizu, Miyagi (JP); Toshihiko Nishiyama, Miyagi (JP); Takashi Mizukoshi, Miyagi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/837,320

(22) Filed: Apr. 30, 2004

(30) Foreign Application Priority Data
Jul. 5, 2003 (JP) 2003-129017

(51) Int. Cl. H01M 8/10; H01M 8/04; H01M 8/12; H01M 4/86; H01M 4/90; H01M 4/96; B05D 5/12

(52) U.S. Cl. 429/30; 429/33; 429/41; 427/115

(57) ABSTRACT

This invention provides an MEA which can prevent crossover. Specifically, this invention provides an MEA comprising a polymer electrolyte membrane and a fuel-electrode catalyst layer and an air-electrode catalyst layer, wherein a polymer compound capable of acting as a co-catalyst is present inside the polymer electrolyte membrane at least near the surface of at least one side. The MEA can be suitably manufactured by a process comprising the steps of applying a monomer for forming a polymer compound capable of acting as a co-catalyst to the surface of at least one side in a polymer electrolyte membrane; polymerizing the monomer; and assembling the polymer electrolyte membrane comprising the polymer compound capable of acting as a co-catalyst, the fuel-electrode catalyst layer and an air-electrode catalyst layer.

### BACKGROUND OF THE INVENTION

1. Field of the Invention

This invention relates to a membrane electrode assembly (hereinafter, referred to as “MEA”) used for a solid-polymer fuel cell, a manufacturing process therefor and a direct type solid-polymer fuel cell with the MEA.

2. Description of the Related Technology

A fuel cell, which utilizes a reverse reaction to electrolysis of water, has been developed in various industrial applications and practically used in expectation of effects on resource saving because it can generate electric energy with a higher efficiency compared with a conventional electric generating method.

A basic structure of a fuel cell comprises an electrolyte membrane for transporting hydrogen ions, a pair of electrodes, i.e., a fuel- and an air-electrodes placed in the sides of the electrolyte membrane, a collector for taking electric power from the electrodes, and a separator separating feeding lines for a fuel and air to the electrodes and electrically interconnecting cells.

There have been developed fuel cells using, as a fuel, hydrogen formed along with carbon dioxide by reaction between, e.g., methanol and water, or hydrogen directly formed methanol by catalytic action of a fuel-electrode by using reformer. Since a liquid fuel such as methanol is more suitable than hydrogen in the light of handling properties and convenience, a direct type fuel cell using hydrogen directly formed from, e.g., methanol has been increasingly expected to be practically useful.

Fuel cells can be categorized into some types such as a fused carbonate, a solid oxide, a phosphate and a solid-polymer type, depending on a type of an electrolyte. One of the properties determining an application of such a fuel cell is an operation temperature. Particularly, a solid-polymer cell has attracted attention because of its operating temperature as low as about 80° C. and is probably applicable to mobile devices.

For the reasons stated above, it is probable that a fuel cell used in a mobile device represented by a laptop computer will be predominantly a direct type solid-polymer fuel cell.

A direct type fuel cell in which a hydrocarbon derivative fuel such as methanol is directly reacted by means of a catalyst in an electrode can be easily size-reduced, but an electrolyte membrane through which only protons can pass may allow a fuel to permeate (so-called, crossover), leading to reduction in an output. Furthermore, the problem may cause inadequate response during output variation.

In a direct type fuel cell, a Pt catalyst is used and a co-catalyst is sometimes used for improving a reaction efficiency. Japanese Laid-open Patent Publication Nos. No 10-55807 and 2000-243406 have disclosed the use of a metal oxide as a co-catalyst. However, Japanese Laid-open Patent Publication No. 10-55807 has disclosed no solutions to the problem of crossover. Furthermore, Japanese Laid-open Patent Publication No. 2000-243406 has disclosed a technique using a photocatalyst, but the above problem cannot be solved by a catalyst alone.

“Conductive Polymer: Basics and Applications” (Dodensei Kobunshi no Kiso to Ouyo) (edited by Katsumi Yoshino, IPC Co. Ltd.) has disclosed that a conductive polymer which is subjected to a reversible electrochemical doping-dedoping reaction with an anion or cation is used as a catalyst electrode. The conductive polymers disclosed in the document cannot be generally used because they exhibit inferior catalyst properties to those of a Pt catalyst.

Japanese Laid-open Patent Publication 2003-68325 has disclosed a technique for preventing crossover, but in the technique, a fuel distributing layer made of a conductive porous material is interposed between an anode and a liquid-fuel impregnated layer, which may lead to a complex structure.

### BRIEF SUMMARY OF THE INVENTION

An objective of this invention is, therefore, to provide an MEA exhibiting an improved generating efficiency and improved response during output variation while preventing crossover, a manufacturing process therefor and a direct type solid-polymer fuel cell therewith.

This invention has been achieved by investigating that a polymer compound capable of acting as a co-catalyst is introduced inside a polymer electrolyte membrane constituting an MEA at least near the surface, in attempting to solve the above problems.

Thus, this invention provides a membrane electrode assembly (MEA) used in a direct type solid-polymer fuel cell comprising a polymer electrolyte membrane and a fuel-electrode catalyst layer and an air-electrode catalyst layer which are assembled with the polymer electrolyte membrane, wherein a polymer compound capable of acting as a co-catalyst is present inside the polymer electrolyte membrane at least near the surface of at least one side.

This invention also provides a MEA as described above, wherein the polymer constituting the polymer electrolyte membrane has an anionic group and the polymer compound capable of acting as a co-catalyst is present near the anionic group.

This invention also provides a MEA as described above, wherein the anionic group is a sulfonic group.

This invention also provides a MEA as described above, wherein the polymer compound capable of acting as a co-catalyst can reversibly react with the anionic group.

This invention also provides a MEA as described above, wherein the polymer compound capable of acting as a co-catalyst is an aromatic polymer compound.

This invention also provides a MEA as described above, wherein the aromatic polymer compound is at least one selected from the group consisting of polypyrrole, polypyrrole derivatives, polythiophene and polythiophene derivatives.

This invention also provides a process for manufacturing a membrane electrode assembly used in a direct type solid-polymer fuel cell, comprising the steps of:
(a) applying a monomer for forming a polymer compound capable of acting as a co-catalyst to the surface of at least one side in a polymer electrolyte membrane;
(b) polymerizing the monomer for forming the polymer compound capable of acting as a co-catalyst inside the polymer electrolyte membrane at least near the surface of at least one side;
(c) assembling the polymer electrolyte membrane comprising the polymer compound capable of acting as a co-catalyst, the fuel-electrode catalyst layer and an air-electrode catalyst layer.

This invention also provides a process for manufacturing an MEA as described above, wherein step (a) is immersing the polymer electrolyte membrane in a solution containing the monomer at the concentration of 0.5 mol/L or less.

This invention also provides a process for manufacturing a membrane electrode assembly as described above, wherein polymerization of step (b) is chemical oxidation polymerization using an oxidizing agent as a catalyst.

This invention also provides a process for manufacturing an membrane electrode assembly as described above, wherein the polymer constituting the polymer electrolyte membrane has an anionic group and the polymer compound capable of acting as a co-catalyst is present near the anionic group.

This invention also provides a process for manufacturing a membrane electrode assembly as described above, wherein the anionic group is a sulfonic group.

This invention also provides a direct type solid-polymer fuel cell comprising any of the MEAs as described above.

According to this invention, there can be provided an MEA exhibiting an improved generating efficiency and improved response during output variation while preventing crossover, a manufacturing process therefor and a direct type solid-polymer fuel cell therewith.

Furthermore, an MEA according to this invention may be assembled without additional components depending on its use. It can contribute to size reduction of a direct type solid-polymer fuel cell and manufacturing cost reduction, and thus may lead to more extensive application of a fuel cell.

### BRIEF DESCRIPTION OF THE SEVERAL VIEWS OF DRAWING

FIG. 1 schematically shows that in a polymer electrolyte membrane made of a perfluorosulfonic acid polymer, anionic groups in the polymer aggregate to form a reversed micelle.

### DETAILED DESCRIPTION OF THE INVENTION

There will be described embodiments of this invention.

In an MEA of this invention, a polymer compound capable of acting as a co-catalyst is present inside a polymer electrolyte membrane at least near the surface of at least one side and the polymer electrolyte membrane is assembled between the fuel-electrode catalyst layer and an air-electrode catalyst layer. The fuel-electrode and the air-electrode catalyst layers may be those for a known fuel cell without limitation.

The polymer electrolyte membrane may be selected without limitation from known polymer electrolyte membranes having a proton conductivity suitable for a fuel cell, i.e., not less than 0.01 S/m; for example, perfluorosulfonic acid polymer electrolyte membrane and hydrocarbon polymer electrolyte membrane. It is preferably made of a polymer having an anionic group because of its higher proton conductivity, more preferably made of a polymer having a sulfonic group. Examples of a polymer having a sulfonic group include perfluorosulfonic acid polymers; particularly preferably, Nafion® series polymer electrolyte membranes from DuPont because of their availability and higher proton conductivity. A specific example may be Nafion® 117 represented by formula (1).

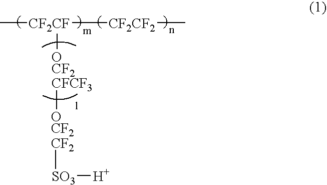

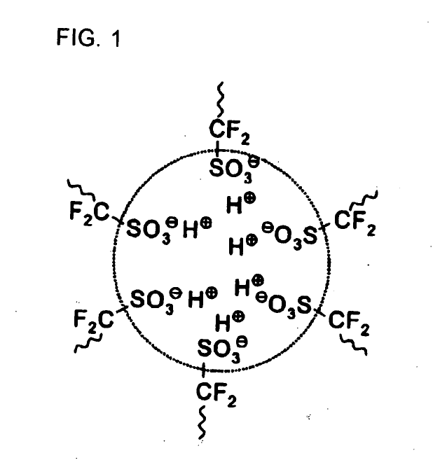

There will be more specifically described the state of a polymer electrolyte membrane made of a polymer having an anionic group. FIG. 1 schematically shows the state of a polymer electrolyte membrane made of a perfluorosulfonic acid polymer, where anionic groups in the polymer aggregate to form a reversed micelle. In this figure, a reversed micelle is seen in the area indicated by the broken line, in which water is trapped to form a cluster. Such reversed micelles are successively formed in the polymer electrolyte membrane to form a proton conducting path. However, as described above, the proton conducting path may be a path for a fuel such as methanol, leading to crossover.

In this invention, a polymer compound capable of acting as a co-catalyst is present inside the polymer electrolyte membrane at least near the surface of at least one side.

A polymer compound capable of acting as a co-catalyst herein means a polymer compound which can compensate for, if present, proton excess or deficiency occurred in an electrode reaction in the fuel cell. Such a polymer compound capable of acting as a co-catalyst present inside the polymer electrolyte membrane at least near the surface of at least one side can promote a redox reaction by protons by compensating for the function of a main catalyst during rapid variation in a temperature, a reactant concentration or an output as a battery, and can compensate for response delay due to a catalytic reaction of the main catalyst.

Furthermore, in this invention, the polymer compound capable of acting as a co-catalyst blocks the proton conducting path in the polymer electrolyte membrane to prevent a fuel from permeating into the polymer electrolyte membrane, resulting in prevention of crossover due to the fuel.

When using a polymer electrolyte membrane made of a polymer having an anionic group, the polymer compound capable of acting as a co-catalyst is preferably present near the anionic group because hydrogen can be generated from the fuel by a reversible doping/dedoping reaction using the anion in the polymer electrolyte membrane as a dopant while the anionic group reacts with a proton as well as crossover can be substantially prevented. Particularly preferably, the anionic group is a sulfonic group because the sulfonic group can promote the doping/dedoping reaction and can be significantly effective as a co-catalyst.

The polymer compound capable of acting as a co-catalyst as described above may be selected from those known in the art; for example, polythiophene, polyaniline, polypyrrole, and their derivatives. An aromatic polymer compound is preferable because it can be easily formed in an electrolyte membrane surface. It is preferably, among others, at least one selected from the group consisting of polypyrrole, polypyrrole derivatives, polythiophene and polythiophene derivatives. Examples of a monomer for forming such a polymer compound include pyrrole, 3-methylpyrrole, thiophene, 3,4-ethylenedioxythiophene and methylthiophene, which may be used in combination of two or more. A polymerization method of the monomer may be chosen, depending on the type of the monomer. For example, for polymerization of 3,4-ethylenedioxythiophene described above, chemical oxidation polymerization using an oxidizing agent such as hydrogen peroxide can be employed.

In this invention, an excessive amount of the polymer compound capable of acting as a co-catalyst present inside the polymer electrolyte membrane at least near the surface of at least one side may interfere with proton migration, leading to reduced proton conductivity. Therefore, an amount of the polymer compound capable of acting as a co-catalyst applied inside the polymer electrolyte membrane at least near the surface of at least one side is appropriately selected depending on the properties, such as proton conductivity and crossover, of the polymer electrolyte membrane itself. At that case, the proton conductivity of the polymer electrolyte membrane having the polymer compound capable of acting as a co-catalyst applied at least near the surface of at least one side is preferably not less than 0.01 S/m.

In addition, if a large amount of the polymer compound capable of acting as a co-catalyst is present in the middle of the polymer electrolyte membrane in the direction of its thickness, a proton conducting path may be electroconductive. In such a state, the polymer electrolyte membrane itself may be electron-conductive, leading to tendency to short circuit. It is, therefore, preferable that in the middle of the polymer electrolyte membrane, the polymer compound capable of acting as a co-catalyst is present as little as possible.

It is preferable that the polymer compound capable of acting as a co-catalyst is present inside the polymer electrolyte membrane near the surface of any one side of the fuel-electrode catalyst layer side and the air-electrode catalyst layer side. Such a polymer electrolyte membrane in which the polymer compound capable of acting as a co-catalyst is present in both sides can be more conveniently manufactured.

The MEA according to this invention as described above can prevent reduction in an output due to crossover and improve response during output variation. A direct type solid-polymer fuel cell comprising the MEA can use a higher concentration of fuel and can minimize output reduction. The cell may be assembled without additional components depending on its use, which may contribute to size reduction in a direct type solid-polymer fuel cell and manufacturing cost reduction, leading to increased applications of the direct type solid-polymer fuel cell.

The MEA as described above can be suitably manufactured by a process for manufacturing a membrane electrode assembly, comprising the steps of:
(a) applying a monomer for forming a polymer compound capable of acting as a co-catalyst to the surface of at least one side in a polymer electrolyte membrane;
(b) polymerizing the monomer for forming the polymer compound capable of acting as a co-catalyst inside the polymer electrolyte membrane at least near the surface of at least one side;
(c) assembling the polymer electrolyte membrane comprising the polymer compound capable of acting as a co-catalyst, the fuel-electrode catalyst layer and an air-electrode catalyst layer. The process will be specifically described below.

First, a monomer for forming a polymer compound capable of acting as a co-catalyst is applied to the surface of at least one side in a polymer electrolyte membrane. Application of the monomer may be conducted by, but not limited to, applying a solution containing the monomer and immersing the membrane in a solution containing the monomer. Immersion in a solution containing the monomer is preferable because it is convenient and the monomer can be applied to both sides. When the monomer is not to be applied to the surface of the other side in the polymer electrolyte membrane, the surface of the side in the polymer electrolyte membrane can be masked.

When using a solution containing a monomer, the solution can preferably form a concentration gradient of applied monomer in a thickness direction of the polymer electrolyte membrane. Examples of a solvent in such a monomer solution are preferably organic solvents which include alcohols such as methanol, cyclic carbonates such as propylene carbonate, and acrylonitrile.

When a polymer electrolyte membrane is immersed in a solution containing the monomer, a monomer concentration in the solution is preferably 0.5 mol/L or less in order to obtain the effective amount of the polymer. An excessively higher concentration may lead to an excessive amount of the monomer applied so that a polymer compound formed after polymerization may also inhibit proton migration, leading to reduction in proton conductivity in the polymer electrolyte membrane. Since an immersion time may have similar effect, the time is preferably chosen such that an appropriate amount of the polymer compound capable of acting as a co-catalyst is present inside the polymer electrolyte membrane at least near the surface finally obtained.

Next, the monomer applied is polymerized to form a polymer compound capable of acting as a co-catalyst inside the polymer electrolyte membrane at least near the surface of at least one side. The polymerization conditions may be appropriately chosen, depending on some factors such as the type of the monomer.

When using a polymer electrolyte membrane made of a polymer having an anionic group, the polymer compound may be preferentially formed near the anionic group in the polymer electrolyte membrane because an area near the anionic group has more affinity to the monomer forming the polymer compound capable of acting as a co-catalyst. As described above, the anionic group in the polymer electrolyte membrane forms a proton conducting path. The area where the polymer compound capable of acting as a co-catalyst is preferentially formed may be near the proton conducting path in the polymer electrolyte membrane, to promote proton exchange with the polymer compound capable of acting as a co-catalyst and to improve an efficiency as a co-catalyst so that even a small amount of the catalyst can effectively work.

Finally, the polymer electrolyte membrane comprising the polymer compound capable of acting as a co-catalyst, a fuel-electrode catalyst layer and an air-electrode catalyst layer are assembled. They can be assembled by hot pressing. Hot pressing can be conducted under the conditions of a temperature of 110 to 130° C., a pressure of approximately 10 MPa and a time of 1 to 30 min.

### EXAMPLES

This invention will be more specifically described with reference to Examples.

### Example 1

As a polymer electrolyte membrane, Nafion® 117, a perfluorosulfonic acid polymer was used. The polymer electrolyte membrane was immersed in an aqueous solution containing hydrogen peroxide as an oxidizing agent at a concentration of 3 mol/L, and then dried. An oxidizing agent may be selected from, but not limited to, various organic oxides such as alkyl sulfonate and alkylbenzene sulfonate and organic peroxides, but hydrogen peroxide is suitable as an oxidizing agent because it is converted into water after reacting as an oxidizing agent so that there may be no need to consider degradation of the polymer compound due to a residual oxidizing agent and reduction in a proton conductivity and because residual impurities in the polymer electrolyte membrane can be dissolved or removed.

Then, the polymer electrolyte membrane was immersed in a 0.1 mol/L solution of 3,4-ethylenedioxythiophene as a monomer for forming a polymer compound capable of acting as a co-catalyst in methanol for 2 min, and then removed from the solution. Then, the membrane was dried at 25° C. for 30 min to polymerize 3,4-ethylenedioxythiophene. In the polymerization reaction during drying, the solution containing the unreacted monomer penetrates into the electrolyte membrane and is then polymerized while evaporation of the solvent from the surface causes diffusion of the solution containing the unreacted monomer from the inside of the polymer electrolyte membrane to the surface of the polymer electrolyte membrane. Thus, a concentration of the polymer compound capable of acting as a co-catalyst is higher near the surface than in the middle of the membrane. When there is a concentration gradient of the oxidizing agent and the monomer, and particularly as is in Nafion®, a side chain has higher affinity to the solvent and the monomer than the principal chain, both of the oxidizing agent solution and the monomer solution can easily penetrate near the sulfonic group in the side chain in the course of diffusion, allowing the polymer compound capable of acting as a co-catalyst to be preferentially formed near the sulfonic group.

The polymer electrolyte membrane prepared had a proton conductivity of 0.050 S/m. The proton conductivity of the polymer electrolyte membrane was determined by alternating current impedance measurement.

In this example, the polymer electrolyte membrane was immersed in the oxidizing agent solution and the monomer solution in sequence, but can be immersed in the reverse sequence. The membrane may be immersed in a solution containing the oxidizing agent and the monomer. At the end of the polymerization process, the polymer electrolyte membrane can be washed and dried for removing the unreacted oxidizing agent and the monomer to provide a polymer electrolyte membrane comprising a polymer compound capable of acting as a co-catalyst near the surface.

Then, an air-electrode catalyst layer and a fuel-electrode catalyst layer were prepared as follows. A solution of Nafion®, a proton conducting polymer, is added to a Pt-catalyst supporting carbon as a catalyst for an air-electrode catalyst layer and a Pt—Ru catalyst supporting carbon as a catalyst for a fuel-electrode catalyst layer to give a catalyst paste, which was then applied to a carbon paper to provide a fuel-electrode catalyst layer and an air-electrode catalyst layer, respectively. The above paste was compounded such that a weight ratio of the catalyst supporting carbon and the proton conducting polymer was 2:1. Then, the polymer electrolyte membrane thus prepared were sandwiched between these catalyst layers and the assembly was hot pressed under the conditions of 130° C., 10 MPa and 1 min, to prepare an MEA.

Thus, a membrane electrode assembly was prepared, in which poly(3,4-ethylenedioxythiophene) was formed in and near the interface between the polymer electrolyte membrane and the fuel-electrode catalyst layer.

### Example 2

An MEA was prepared as described in Example 1, except the concentration of 3,4-ethylenedioxythiophene as a monomer for forming a polymer compound capable of acting as a co-catalyst in the solution was 0.3 mol/L. The polymer electrolyte membrane prepared had a proton conductivity of 0.056 S/m.

### Example 3

An MEA was prepared as described in Example 1, except the concentration of 3,4-ethylenedioxythiophene as a monomer for forming a polymer compound capable of acting as a co-catalyst in the solution was 0.5 mol/L. The polymer electrolyte membrane prepared had a proton conductivity of 0.063 S/m.

### Example 4

An MEA was prepared as described in Example 1, except a monomer for forming a polymer compound capable of acting as a co-catalyst was pyrrole and its concentration in the solution was 0.1 mol/L. The polymer electrolyte membrane prepared had a proton conductivity of 0.045 S/m.

### Comparative Example 1

Nafion® 117 was sandwiched between the catalyst layers prepared as described in Example 1, and the assembly was hot-pressed under the conditions of 130° C., 10 MPa and 1 min, to give an untreated MEA. It was immersed in a 3 mol/L aqueous solution of hydrogen peroxide for 2 hours and then in a 0.1 mol/L solution of 3,4-ethylenedioxythiophene in methanol for 2 min, and then removed from the solution. Subsequently, the assembly was dried at 25° C. for 30 min for polymerizing 3,4-ethylenedioxythiophene to provide an MEA.

### Comparative Example 2

Nafion® 117 was sandwiched between the catalyst layers prepared as described in Example 1 and hot-pressed under the conditions of 130° C., 10 MPa and 1 min. The assembly as such was used as an MEA.

For the polymer electrolyte membranes in Examples 1 to 4 and Comparative Example 2, a methanol permeability was determined by gas chromatography. Specifically, it was calculated by the time dependence of methanol concentration in the water, which was evaluated by gas chromatography, when the polymer electrolyte membrane was set between methanol and water. In addition, single-cell fuel cells were assembled using the MEAs in Examples 1 to 4 and Comparative Examples 1 and 2. For the cells, a voltage and a time before a voltage became stable when a current was varied from 400 mA to 200 mA at room temperature under without pressuring a fuel or the air were determined. The results are summarized in Table 1. In this table, a methanol permeability is a relative value, assuming that a methanol permeability for Comparative Example 2 is 100; a voltage is a voltage after varying a current; a stabilizing time is a time before a voltage became stable.

TABLE 1

| | | Methanol | Voltage | Stabilizing Time |
|---|---|---|---|---|
| | | Permeability | (mV) | (sec) |
| Example | 1 | 85 | 380 | 20 |
| | 2 | 67 | 375 | 18 |
| | 3 | 53 | 365 | 15 |
| | 4 | 83 | 383 | 21 |
| Comp. | 1 | — | 375 | 28 |
| Example | 2 | 100 | 385 | 23 |

The results of a methanol permeability shown in Table 1 demonstrate that a permeability value decreases as a concentration of a monomer for forming a polymer compound capable of acting as a co-catalyst in a solution increases. It would be because a polymer compound capable of acting as a co-catalyst is present in a proton path in the polymer electrolyte membrane. It unambiguously indicates crossover preventing effect of this invention.

A voltage after varying a current is reduced by up to 5.2% in relation to Comparative Examples, which is not a substantial difference, while a time before a voltage becomes stable is reduced by up to 34.7%. It is obvious from the results that this invention improved response during output variation in a direct type solid-polymer fuel cell.

Although being not shown as value results, it was confirmed that in a concentration range of a monomer for forming a polymer compound capable of acting as a co-catalyst of more than 0.5 mol/L, an immersion time of a polymer electrolyte membrane could be reduced to give properties equivalent to those in Examples 1 to 4, but fluctuation tended to be increased, indicating that a desirable concentration is 0.5 mol/L or less.

While the invention has been described in its preferred embodiments, it is to be understood that various changes and modifications may be made in the invention without departing from the spirit and scope thereof.

1. A membrane electrode assembly used in a direct type solid-polymer fuel cell comprising a polymer electrolyte membrane, and a fuel-electrode catalyst layer and an air-electrode catalyst layer which are assembled with the polymer electrolyte membrane, wherein a polymer compound capable of acting as a co-catalyst is present inside the polymer electrolyte membrane at least near the surface of at least one side.

2. A membrane electrode assembly as claimed in claim 1, wherein the polymer constituting the polymer electrolyte membrane has an anionic group and the polymer compound capable of acting as a co-catalyst is present near the anionic group.

3. A membrane electrode assembly as claimed in claim 2, wherein the anionic group is a sulfonic group.

4. A membrane electrode assembly as claimed in claim 2, wherein the polymer compound capable of acting as a co-catalyst can reversibly react with the anionic group.

5. A membrane electrode assembly as claimed in claim 1, wherein the polymer compound capable of acting as a co-catalyst is an aromatic polymer compound.

6. A membrane electrode assembly as claimed in claim 5, wherein the aromatic polymer compound is at least one selected from the group consisting of polypyrrole, polypyrrole derivatives, polythiophene and polythiophene derivatives.

7. A process for manufacturing a membrane electrode assembly used in a direct type solid-polymer fuel cell, comprising the steps of:
(a) applying a monomer for forming a polymer compound capable of acting as a co-catalyst to the surface of at least one side in a polymer electrolyte membrane;
(b) polymerizing the monomer for forming the polymer compound capable of acting as a co-catalyst inside the polymer electrolyte membrane at least near the surface of at least one side;
(c) assembling the polymer electrolyte membrane comprising the polymer compound capable of acting as a co-catalyst, the fuel-electrode catalyst layer and an air-electrode catalyst layer.

8. A process for manufacturing an membrane electrode assembly as claimed in claim 7, wherein step (a) is immersing the polymer electrolyte membrane in a solution containing the monomer at the concentration of 0.5 mol/L or less.

9. A process for manufacturing an membrane electrode assembly as claimed in claim 7, wherein polymerization of step (b) is chemical oxidation polymerization using an oxidizing agent as a catalyst.

10. A process for manufacturing a membrane electrode assembly as claimed in claim 9, wherein the polymer constituting the polymer electrolyte membrane has an anionic group and the polymer compound capable of acting as a co-catalyst is present near the anionic group.

11. A process for manufacturing a membrane electrode assembly as claimed in claim 10, wherein the anionic group is a sulfonic group.

12. A direct type solid-polymer fuel cell comprising the membrane electrode assembly as claimed in claim 1.
